(19) United States
(12) Patent Application Publication
(10) Pub. No.: US 2019/0370848 A1
(43) Pub. Date: Dec. 5, 2019

(54) MESSAGING SYSTEM AND METHOD

(71) Applicant: Capital One Services, LLC, McLean, VA (US)

(72) Inventors: Salik SHAH, Washington, DC (US); Michael MOSSOBA, Arlington, VA (US)

(73) Assignee: Capital One Services, LLC, McLean, VA (US)

(21) Appl. No.: 16/000,558

(22) Filed: Jun. 5, 2018

Related U.S. Application Data
(63) Continuation of application No. 15/995,429, filed on Jun. 1, 2018.

(51) Int. Cl. G06Q 30/02; H04L 12/58; G06F 17/30

(52) U.S. Cl. CPC G06Q 30/0241; G06F 15/18; G06F 17/30598; H04L 51/02

(57) ABSTRACT

A messaging system and method for providing a messaging system is disclosed. In some embodiments, systems and methods send a message to a first group of recipients, receive interaction data, evaluate whether that data represents a positive or negative interaction, associate with that data with a characteristic of each recipient of the message, and determine another group of recipients to receive the message.

### TECHNICAL FIELD

This disclosure generally relates to big data analytics, and more particularly, machine learning applications to improve marketing campaigns.

### BACKGROUND

Marketers often use emails and listservs to communicate with and advertise to consumers. These are often mass emails sent to a group of consumers determined through a variety of means. Sometimes the determination of the group is made through information gathered when consumer contact information is received, such as after a consumer visits a specific website or signs up for a particular service. This information may suggest types of information the consumer may find interesting or useful. But the automatic collection of contact information may limit accuracy, and the effectiveness of mass emails may be correspondingly reduced.

These problems are due to a number of challenges, particularly in gathering, analyzing, and utilizing data a system receives. One of the challenges is knowing whether the recipient actually read the email received in the mass emailing and, if read, what the recipient's reaction was. Did the email drive the recipient to an advertised product, for example, by causing the recipient to follow a hyperlink or otherwise buy the product? Such actions by the recipient may be difficult to determine. Marketers want to avoid multiple mass emails because they decrease the chance that the email will be read. Another challenge is that recipients often sort marketing emails into spam folders or otherwise delete them immediately.

### SUMMARY

In accordance with the present disclosure, there is provided a messaging system including one or more memory devices storing instructions and one or more processors. The one or more processors are configured to execute the instructions to associate each of a group of prospective recipients with at least one characteristic; send a message to a group of first recipients, the group of first recipients being selected from the group of prospective recipients; associate the recipients with at least one characteristic; receive interaction data representing a response of each first recipient to the message; evaluate the interaction data and determine whether the response was positive or negative; associate the interaction data with the at least one characteristic of each first recipient; and determine a group of second recipients based on the positive and negative response associated with the characteristics.

Also in accordance with the present disclosure herein provided, a system for a dynamic advertising campaign, including one or more memory devices storing instructions and one or more processors. The one or more processors are configured to execute instructions to associate each of a group of prospective recipients with at least one characteristic; send an message to a group of first recipients, the group of first recipients being selected from the group of prospective recipients; associate the recipients with at least one characteristic; receive interaction data representing a response of each first recipient to the message; evaluate the interaction data and determine whether the response was positive or negative; associate the interaction data with the at least one characteristic characteristics of each first recipient in real time; determine a group of second recipients based on the positive and negative response associated with the at least one characteristic; and continue to determine subsequent groups of recipients to receive the message based on positive or negative responses of an immediately preceding group of recipients until one of a predetermined threshold of positive responses is reached or a determined amount of time is exceeded.

The disclosed embodiments include, for example, a messaging system including one or more memory devices storing instructions and one or more processors. The one or more processors are configured to execute the instructions to associate each of a group of prospective recipients with at least one characteristic; send a message to a group of first recipients as a first experiment, the group of first recipients being selected from a group of prospective recipients; receive data representing an interaction of each first recipient to the message; identify positive or negative feedback in the received data and associate a response to the message by each first recipient with the at least one characteristic of the associated first recipient; identify each characteristic associated with positive feedback; determine a group of second recipients for a second experiment by selecting second recipients having at least one of the characteristics associated with positive feedback; continue to run additional experiments until results of an experiment meet a determined threshold for the at least one characteristic, each additional experiment being run by determining an experimental group of recipients having at least one of the characteristics associated with positive feedback in a previous one of the experiments; and send the message to a group of recipients larger than any of the groups of recipients in the experiments, with the selected group of recipients being based on the characteristics determined from the experiments to be associated with positive feedback.

Another embodiment of the invention allows the system to modify both the content of the email and the list of recipients that receive the message. The disclosed embodiments include, for example, a messaging system including one or more memory devices storing instructions and one or more processors. The processors are configured to execute the instructions to send a message to a group of first recipients, each recipient associated with a characteristic, the message including elements in the message; send the message to the group of first recipients, the group of first recipients being selected from a group of prospective recipients; associate the elements with the recipients' characteristics; receive the interaction data representing a response of each first recipient to the message; analyze the interaction and determine whether the response was positive or negative; associate the response with the at least one characteristic; choose characteristics that it wishes to send a second message to; create a new message including elements based on the positive and negative association of those elements with the selected characteristics; send the message.

The disclosed embodiments include, for example, a messaging system including one or more memory devices storing instructions and one or more processors. The processors are configured to execute the instructions to send a message to a group of first recipients as an experiment; associate the recipients and the elements of the message with at least one characteristic; receives interaction data representing a response of the recipients to the message; evaluate the interaction data and determine whether the interaction was positive or negative; select at least one characteristic; create a second message containing elements that are positively or negatively associated with the selected characteristics; create a group of second recipients based on whether the recipients are associated with the characteristics as a second experiment; continue to run experiments until the messages receive a predetermined threshold for the responses to the characteristics; send a new message to a group of recipients larger than any of the preceding experiments, with the new group being based on the characteristics that are associated with positive feedback in the experiment.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a block diagram of an exemplary system in which to implement a messaging system;

FIG. 2 is a block diagram of an exemplary computing device;

FIG. 3 is a flowchart of an exemplary data handling process in accordance with disclosed embodiments;

FIG. 4 is a flowchart of an exemplary data handling process in accordance with disclosed embodiments;

FIG. 5 is a flowchart of an exemplary data handling process in accordance with disclosed embodiments;

FIG. 6 is a flowchart of an exemplary data handling process in accordance with disclosed embodiments;

FIG. 7 is a flowchart of an exemplary data handling process in accordance with disclosed embodiments; and

FIG. 8 is a flowchart of an exemplary data handling process in accordance with disclosed embodiments.

### DETAILED DESCRIPTION

The present disclosure addresses the disadvantages of the prior art by providing novel systems, methods, and techniques for providing a messaging system that can learn to predict reactions of recipients to messages they receive and learn to build better groups of recipients and emails for those groups. Unlike any prior implementations, the disclosed systems and methods improve the systems used to create marketing listservs by gathering data from the recipients and using that data to determine subsequent groups of recipients.

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

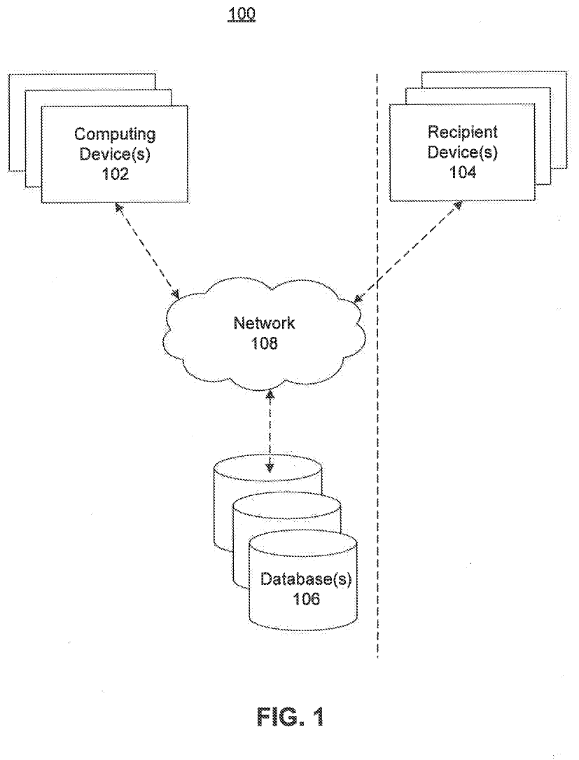

FIG. 1 is a block diagram illustrating an exemplary system 100 for creating and sending marketing messages to determined lists of recipients, in accordance with the disclosed embodiments. The components and arrangements shown in FIG. 1 are not intended to limit the disclosed embodiments, as components used to implement disclosed processes and features may vary.

System 100 includes one or more computing devices 102, one or more databases 106, and network(s) 108. The components of system 100 are configured to communicate with recipient device(s) 104, by sending messages, including emails, instant messages, or other types of communications, collectively referred to herein as emails or messages, and receiving information from recipient device(s) 104, as described more fully below. Other components known to one of ordinary skill in the art may be included in system 100 to gather, process, transmit, receive, acquire, and provide information used in conjunction with the disclosed embodiments. In addition, system 100 may further include other components that perform or assist in the performance of one or more processes that are consistent with the disclosed embodiments. While the features and operation of system 100 are described primarily for creating and sending emails related to marketing, to recipients, the present disclosure is not so limited. Systems and methods consistent with the present disclosure can also create and send other forms of messages for marketing, to recipients, including instant messages, notifications, communications on websites, and more.

In some embodiments, system 100 may include one or more network(s) 108. Network 108 may comprise any computer networking arrangement used to exchange data. For example, network 108 may be the Internet, a private data network, a virtual private network (VPN) using a public network, and/or other suitable connections that enable the components of system 100 to send and receive information. Network 108 may also include a public switched telephone network (“PSTN”) and/or a wireless network such as a cellular network, wired Wide Area Network, Wi-Fi network, and/or another known wireless network (e.g., WiMAX) capable of bidirectional data transmission.

Network 108 connects to recipient device(s) 104. Recipient device 104 may be a computing system that is associated with a recipient. A recipient may be any person that uses an email program. Recipient device 104 may include an email or other messaging application that allows a recipient to communicate with others. Thus, recipient device 104 may use the application to communicate with systems sending emails to large groups of recipients. Marketers, for example, may want to create lists to reach large groups of potential customers by messaging. Further, recipient device 104 is not limited to conducting businesses in any particular industry or field.

Recipient device 104 may include a computing device configured to communicate via the network 108 to send data about a recipient's interaction with an email it received from computing device 102. For example, recipient device 104 may include one or more memory devices storing data and software instructions and one or more processors configured to use the data and execute the software instructions to perform operations including sending data about interaction with an email received from computing device 102, such operations being known to those skilled in the art. In some embodiments, recipient device 104 may have an application installed thereon to perform one or more processes that are consistent with the disclosed embodiments.

Recipient device 104 may further include servers, as known in the art, that are configured to execute stored software instructions to perform operations associated with a recipient, including processes associated with sending and receiving messages, generating interaction data, etc. Recipient device 104 may be a general-purpose computer, a mobile phone, a tablet, a multifunctional watch, or any device suitable device with computing capability. In certain embodiments, recipient device 104 (or a system including recipient device 104) may be configured as an apparatus, system, and the like, based on storage, execution, and/or implementation of software instructions that perform one or more operations consistent with the disclosed embodiments. In some embodiments, recipient device 104 may transmit data to the computing device 102 about interaction with an email received therefrom. For example, recipient device 104 may connect to the computing device 102 via network 108 by use of web browser software.

In some embodiments, system 100 includes one or more database(s) 106. Database 106 includes one or more memory devices that store information. By way of example, database 106 may include Oracle™ databases, Sybase™ databases, or other relational databases or non-relational databases, such as Hadoop sequence files, HBase™, or Cassandra™. The databases or other files may include, for example, data and information related to a source and destination of a network request, data contained in the request, etc. Systems and methods of disclosed embodiments, however, are not limited to separate databases. Database 106 may include computing components (e.g., database management system, database server, etc.) configured to acquire and process requests for data stored in memory devices of database 106 and to provide data from database 106.

Each recipient device 104 may send interaction data in response to an email received from computing device 102. When computing device 102 receives interaction data from one of recipient devices 104, the incoming interaction data may be associated with the recipient. Incoming interaction data could include information indicating whether the recipient opened the email, followed a hyperlink included in the body of the email, deleted the email without opening it, or any other relevant information regarding the recipient's interaction with the email.

Emails, including marketing emails, sent by computing device 102 to one or more recipient device 104, are generally the email referred to herein as email. The email may include one or more elements, such as a text body, hyperlinks, images, or other elements known in the art. The email, additionally or alternatively, may include instructions, for example, that instruct the recipient device 104 to send the interaction data back to computing device 102. The email may also include tracking pixels, cookies, and other features known in the art. Moreover, in some embodiments, system 100 may send the same email to different groups of recipients.

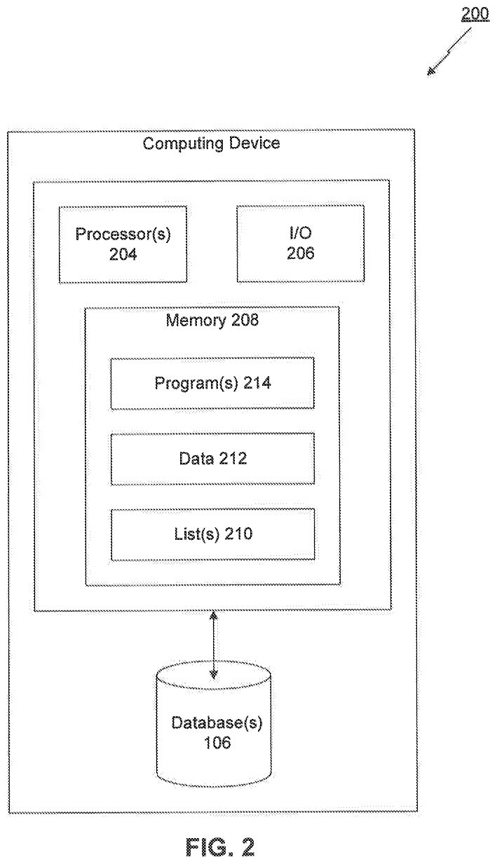

FIG. 2 is a block diagram of an exemplary computing device 200 in accordance with the disclosed embodiments. Computing device 102 may be provided as computing device 200. As shown, computing device 200 includes one or more processor(s) 204, one or more input/output (“I/O”) device(s) 206, and one or more memory device(s) 208 including a list 210 of email addresses of prospective recipients. Memory device 208 also stores data 212, including interaction data and other data. The interaction data may include, for example, whether the recipient opened the email, followed hyperlinks, sorted the email as junk, deleted the email without opening it, and other data indicating how the recipient interacted with the email. Memory device 208 also stores one or more program(s) 214. Computing device 200 may be implemented in a single server or in a distributed computing system including multiple servers or computers (e.g., a cloud service, server clusters, or other systems known in the art) that interoperate to perform one or more of the processes and functionalities associated with the disclosed embodiments. In some embodiments, computing device 200 is specially configured with hardware and/or software modules for performing functions of the disclosed methods. The components of computing device 200 may be implemented as specialized circuitry integrated within processor 204 or in communication with processor 204, and/or as specialized software stored in memory device 208 executable by processor 204.

Processor 204 may be implemented as one or more known or custom processing devices designed to perform functions of the disclosed methods, such as single- or multiple-core processors capable of executing parallel processes simultaneously to allow computing device 200 to execute multiple processes simultaneously. For example, processor 204 may be configured with virtual processing technologies. Processor 204 may implement virtual machine technologies, including a Java virtual machine, or other known technologies to provide the ability to execute, control, run, manipulate, store, etc., multiple software processes, applications, programs, etc. One of ordinary skill in the art would understand that other types of processor arrangements could be implemented that provide for the capabilities disclosed herein.

I/O device 206 may comprise one or more interfaces for receiving input signals from other devices and for providing output signals to other devices to allow data to be received and/or transmitted by computing device 200. I/O device 206 may also include interface components that display information and/or provide interfaces to one or more input devices, such as one or more keyboards, mouse devices, and the like, to enable computing device 200 to receive input from a recipient (not shown).

Memory device 208 may include instructions to enable processor 204 to execute programs 214, such as one or more operating systems, server applications, network communication processes, and any other type of application or software known to be available on computer systems. Alternatively or additionally, instructions may be stored in remote storage (not shown) in communication with computing device 200, such as one or more database or memory modules accessible over network 108. The internal database and external storage may be implemented in volatile or non-volatile, magnetic, semiconductor, tape, optical, removable, non-removable, or another type of storage device or tangible (i.e., non-transitory) computer-readable medium.

In some embodiments, memory device 208 includes instructions that, when executed by processor 204, perform one or more processes consistent with the functionalities disclosed herein. Methods, systems, and articles of manufacture consistent with the disclosed embodiments are not limited to separate programs or computers configured to perform dedicated tasks. For example, memory device 208 may include one or more programs 214 and/or listserv applications, as described more fully below, for execution by processor(s) 204 to perform one or more functions of the disclosed embodiments. Moreover, processor 204 may execute one or more programs located remotely from computing device 200. For example, computing device 200 may access one or more remote programs, that, when executed, perform functions related to disclosed embodiments.

Programs 214 may also include one or more machine learning, trending, and/or pattern recognition applications (not shown) that cause processor 204 to execute one or more processes related to providing a dynamic listserv program. For example, the machine learning, trending, and/or pattern recognition may provide, modify, or suggest input variables associated with one or more other programs 214. Program(s) 214 may include, for example, an operating system. Program(s) 214 may be implemented or integrated using one or more commercial and/or open sourced platforms, such as Chassis™, PostgreSQL™, Apache Kafka™, Open NLP™, Spark™, Amazon Web Services™, Docker™, Jenkins™, HTML™, CSS™, Less™, AngularJS™, etc.

Memory 208 may further include program(s) 214 in accordance with the disclosed embodiments. Program(s) 214 may further include components that facilitate learning and data analysis by processor(s) 204, such as one or more data processing module(s), machine learning module(s), artificial intelligence module(s), neural network module(s), analytic module(s), and/or other modules. Various components of program(s) 214 may be used in the disclosed embodiments. Program(s) 214 may be constructed in a highly adaptive way, such as using, for example, representation state transfer technology.

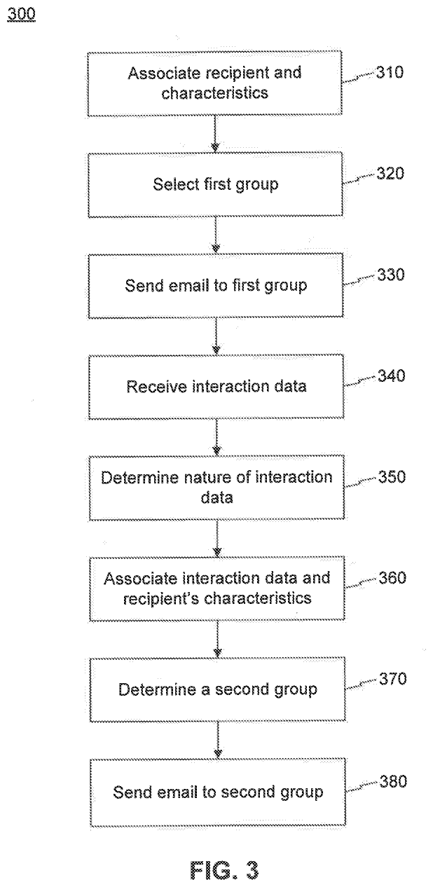

FIG. 3 is a flowchart illustrating steps of an exemplary data handling process 300 that may be performed by processor(s) 204 in accordance with disclosed embodiments. However, the steps illustrated in the flowchart are only exemplary. One or more steps may be added or deleted to implement data handling process 300.

At step 310, processor 204 associates each recipient in list 210 with characteristics in the data it has on the recipients. Processor 204 may be programmed to associate as few or as many characteristics as needed. These characteristics will be used, as described further below, to create other groups of recipients. These characteristics can include information such as location, socioeconomic status, past transaction information, device type, browser type, demographic data, and any other information known in the art as useful for marketing purposes.

For example, in some embodiments, the past transaction information could represent whether the recipient shops with a specific retailer, buys certain types of products, or how often the recipient generally shops online.

At step 320, processor 204 selects a group of first recipients from list 210. Memory device 208, or one of the other data storage devices described above, has acquired and stores data related to the recipients. As described above, the data may represent contact information, characteristics of each recipient, or any other data gathered related to each recipient. For example, in some embodiments the group may be randomly selected from list 210. As another example, in some embodiments, selecting this group of first recipients may be based on a process similar to processes disclosed in this application, and step 320 may be another iteration of such a process.

Processor 204 may use other techniques for selecting the group of first recipients, such as importing lists from other sources or third parties, or other processes known in the art.

At step 330, processor 204 sends the email to the group of first recipients. The email can be sent through typical means known in the art. The email may include instructions that cause recipient device 104 to send interaction data back to computing device 200.

At step 340, processor 204 receives interaction data from recipient device(s)104 of the first recipients. In some embodiments, interaction data could include whether the email was opened by the recipient, whether the recipient clicked on any hyperlinks within the email, or any other interactions with the email known in the art.

At step 350, processor 204 evaluates the interaction data to determine whether it is positive or negative. For example, in some embodiments, opening the email is considered a positive response. As another example, in some embodiments, designating the email as spam is considered a negative response. Particular definitions of positive or negative interactions are established when the system is set up.

At step 360, processor 204 associates the interaction data with the characteristics of the recipient. This step allows processor 204 to learn which characteristics relate to positive or negative interaction with the email. As described above, program(s) 214 include program component(s) that facilitate learning and analysis by processor(s) 204. These program(s) 214 that facilitate learning allow processor 204 to operate more efficiently by allowing system 100 to improve predictions of best recipients for future emails. System 100 may store the data gathered during the disclosed processes and use the data to create the first groups of recipients and first emails.

For example, if a characteristic is that a recipient shops at a particular merchant A, processor 204 may collect interaction data that shows whether a person who shops at merchant A interacted positively or negatively with the email. Processor 204 may then aggregate the interaction data of several recipients associated with shopping at merchant A to predict whether future recipients who shop at merchant A are likely to interact positively or negatively with the email.

Determining whether a characteristic relates to positive or negative interaction with the email can take various forms. For example, in some embodiments, the characteristic may be given an interaction data score. This interaction data score could be a percentage of positive interactions relative to the total interactions or a percentage of negative interactions relative to the total interactions. In another embodiment, the interaction data score could be a weighted score in which certain interactions are considered to be more positive or negative than others. For example, a recipient clicking on a hyperlink within the email could be worth double the weight of merely opening the email. Persons skilled in the art will now recognize that these examples are not limiting, and that there are other parameters that could be used for scoring. Further, persons skilled in the art will now recognize that such parameters could be implemented to this system.

At step 370, processor 204 determines a group of second recipients. This group of second recipients is determined using the interaction data associated with various characteristics. The particular requirements of the group of second recipients is configurable by computing device 200. The group of second recipients can be determined by processor 204 adding recipients from list 210, to initially contain all members of the listserv and then remove certain recipients from the group based on interaction data, or any other means.

In one exemplary embodiment, processor 204 determines that the group of second recipients includes all persons with a characteristic associated with a threshold number of positive responses. Similarly, processor 204 could exclude all recipients associated with a characteristic associated with a threshold number of negative responses. In another example, processor 204 could select the group of second recipients based on the interaction data score. More particularly, processor 204 could include all recipients within a designated range or above a designated threshold of the interaction data score.

At step 380, processor 204 sends the email to the group of second recipients. This can be accomplished through the email or messaging systems discussed above. It should also be understood that while process 300 describes the groups as having “first” and “second” recipients, this process can be repeated and applied to as many additional groups of recipients as desired. It should also be understood that minor modifications, some of which are described below, can be implemented to adjust system 100 to the specific needs of the system.

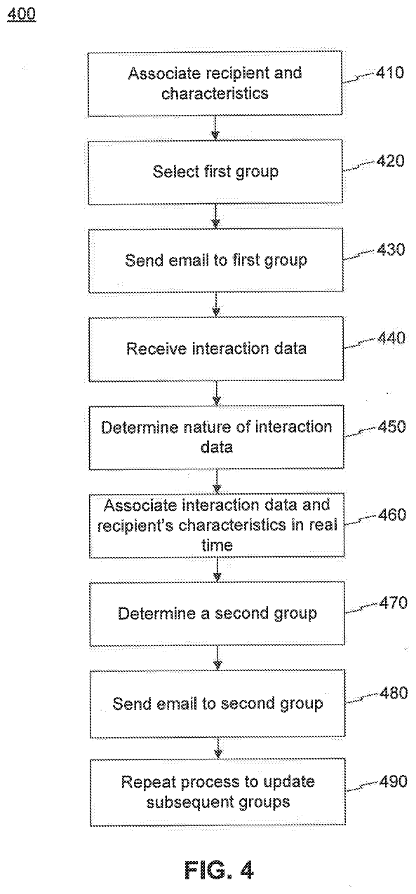

FIG. 4 is a flowchart, illustrating an exemplary data handling process 400 in accordance with disclosed embodiments. Process 400 implements a system for a dynamic advertising campaign, including several steps corresponding to steps of process 300. More particularly, steps 410-450, 470, and 480 of process 400 correspond to, and are substantially the same as, steps 310-350, and 370 and 380, respectively, of process 300. These corresponding steps are described within the description of process 300 and are not described here.

Process 400 differs, in part, from process 300 by steps 460 and 490. Step 460 adds a feature of associate the interaction data with the characteristics of the recipient in real time. In some embodiments, such associating in real time allows the system to build groups of subsequent recipients based on time, rather than waiting for interaction data from all recipients. In such embodiments, data associated with the characteristics, and the interaction data score or other metrics, will be based on the most up-to-date information, enabling the data to be used whenever needed.

Step 490 includes use of the information updated in real time. This embodiment allows processor 204 to send emails to subsequent groups of recipients based on a designated time interval, or other predetermined triggering event, without waiting for responses from all previous recipients. Such additional aspects of process 400 are not limiting on the process 300 above, but instead illustrate further capabilities of system 100.

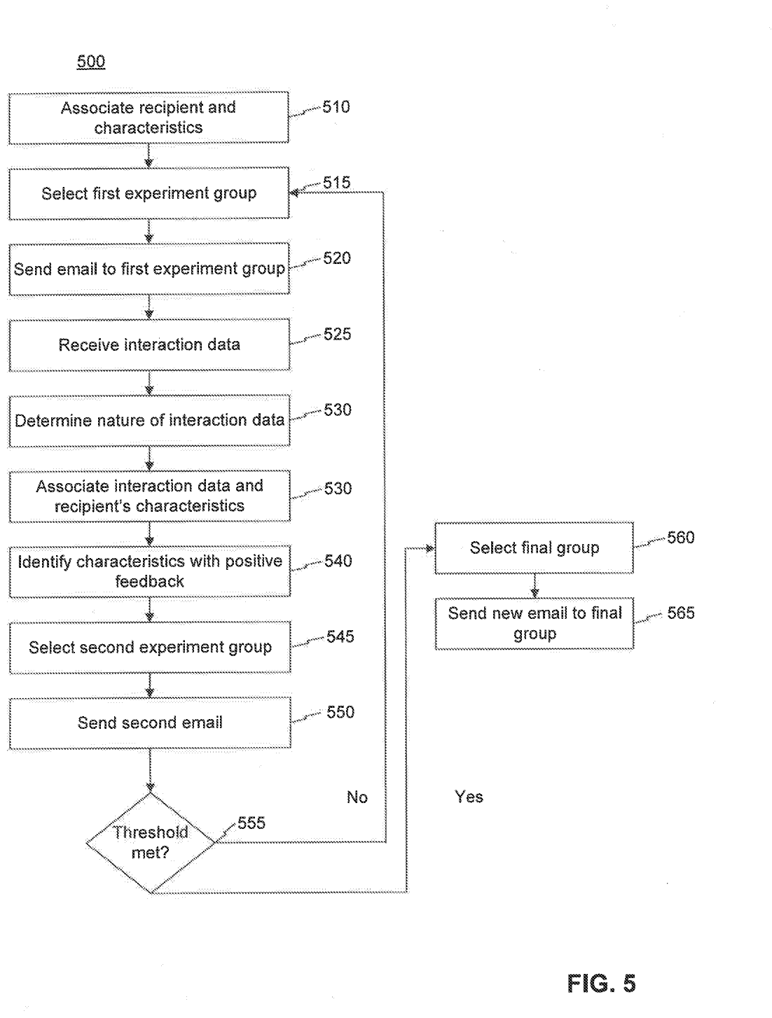

FIG. 5 is a flowchart illustrating an exemplary data handling process 500 in accordance with disclosed embodiments. Process 500 includes several steps corresponding to steps of process 300. These corresponding steps are described within the description of process 300 and are not described here.

Process 500 differs, in part, in steps 515 and 540-565. In these steps, process 500 implements another embodiment of process 300 wherein initial groups of recipients are selected as experiments before a mass email is sent to a larger group of recipients. According to process 500, processor 204 selects the group of first recipients as a first experiment group, at step 515.

At step 540, processor 204 identifies characteristics that are associated with positive responses. As discussed previously, this can take the form of having a predetermined number of positive responses, a percentage of positive responses relative to the total responses, certain interaction data scores, and other qualitative measurements.

At step 545, processor 204 selects a second experiment group of recipients based on these characteristics associated with positive responses.

At step 550, processor 204 sends an email with the same content to the second experiment group recipients, as similarly discussed above for step 380 of process 300.

At step 555, processor 204 collects the responses with interaction data from the second experiment group. If the interaction data meets a predetermined threshold requirement (step 555—yes), then processor 204 proceeds to step 560a to create a final group of recipients based on all potential recipients in the list 210 having the characteristics that met the threshold requirement.

If the threshold requirement is not met (step 555—no), then processor 204 proceeds to 560b and repeats the earlier steps of process 500 until characteristics that meet the threshold requirement are identified.

The threshold requirement can be selected in various ways. For example, in some embodiments, the threshold requirement may be set by a system administrator or other person involved with the email. In other embodiments, system 100 may include automated systems for creating the threshold requirement. One skilled in the art will now recognize that there are various ways to select a predetermined threshold requirement and that those processes may be implemented in process 500.

The threshold requirement can take various forms. For example, in some embodiments, the threshold requirement may be a total number of positive responses, a percentage of positive responses relative to the total number of responses, an interaction data score as described above, and any other qualitative measurement or analysis.

For example, in some embodiments, processor 204 may add to the second experiment group of recipients all potential recipients with a characteristic that received a threshold number of positive responses. Similarly, processor 204 may exclude from the second experiment group all recipients associated with a characteristic that received a threshold number of negative responses. In another example, processor 204 may select the second experiment group recipients based on the interaction data score. Processor 204 could include all potential recipients within a designated range or above a designated threshold of the interaction data score.

At step 565, processor 204 sends a new email with the same content to the group of final recipients. This can be accomplished through the email or messaging systems discussed above. It should also be understood that while process 300 describes groups of “first” and “second” emails and recipients, process 500 can be repeated and applied to as many additional emails and groups of recipients as desired, e.g., resulting in successive second experiment groups. It should also be understood that minor modifications, some of which are described throughout this specification, can be implemented to adjust system 100 to the specific campaign's needs.

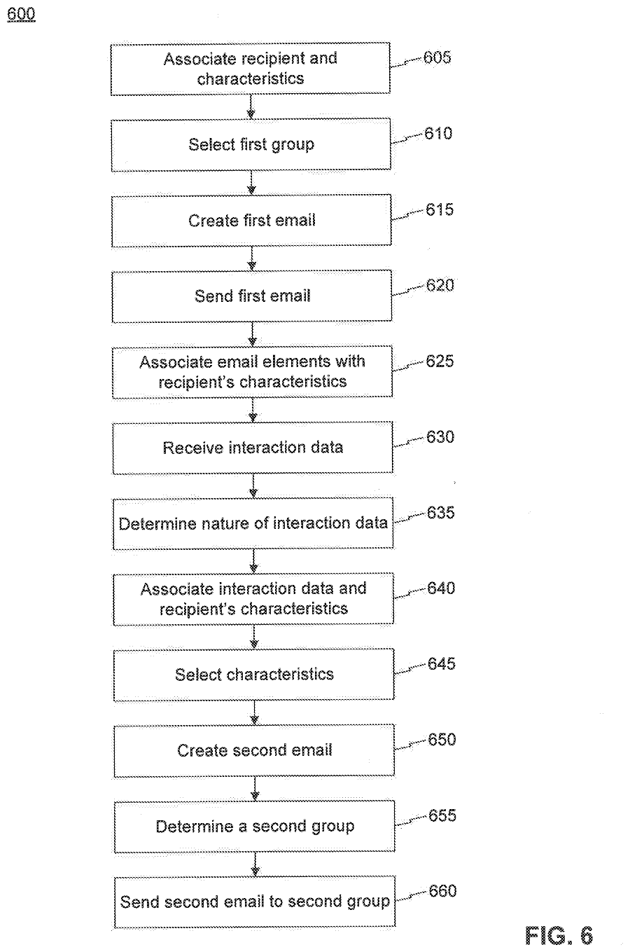

FIG. 6 is a flowchart illustrating steps of an exemplary data handling process 600 that may be performed by processor(s) 204 in accordance with disclosed embodiments. However, the steps illustrated in the flowchart are only exemplary. One or more steps may be added or deleted to implement data handling process 600.

At step 605, processor 204 associates each recipient in list 210 with characteristics in data it has on the recipients. Processor 204 can be programmed to associate as few or as many characteristics as desired. These characteristics are used, as described below, to create other emails and groups of recipients. These characteristics can include information such as location, socioeconomic status, past transaction information, and any other information known to be useful for marketing purposes.

For example, in some embodiments, the past transaction information could represent whether the recipient shops with a specific retailer, buys certain types of products, or how often they generally shop online.

At step 610, processor 204 selects a group of first recipients from list 210. Memory device 208, or one of the other data storage devices described above, has acquired and stored data related to the recipients. As described above, the data may represent contact information, characteristics of the recipient, or any other data gathered related to the recipient. For example, in some embodiments the group may be randomly selected from list 210. As another example, in some embodiments, selection of the group of “first” recipients may be based on a process similar to ones disclosed elsewhere in this application, and step 610 may be another iteration of such similar process.

Processor 204 may use other techniques for creating the group of first recipients, such as importing lists from other sources or third parties, or other processes known in the art.

At step 615, processor 204 creates a first email. The email contains elements that represent different portions of the content in the email. For example, an element may be a paragraph, a picture, a hyperlink, or any other grouping of content that may be included within the email, including any combination of the types of elements described herein. In one embodiment, these elements may be selected from a group or groups of elements stored in memory device 208.

In other embodiments, there may be one group or multiple groups of emails. For example, system 100 may include three elements in the email. System 100 may have a group for each of the elements, e.g., group A for element 1, group B for element 2, and group C for element 3, where, for example, group A is a group of paragraph elements, group B is a group of picture elements, and group C is a group of hyperlinks. Processor 204 may have instructions to select elements from group A for element 1, then another element from group B for element 2, and a third element from group C for element 3. With these elements selected, processor 204 has created an email. Alternatively, this selection may take place in a future iteration of the process described for this or any other embodiment. In this case, selecting the elements may be based on the data associated with the elements similar to later steps in process 600.

At step 620, processor 204 sends the email to the group of first recipients. The email can be sent through typical means known in the art. The email may include instructions such that the recipient device 104 sends interaction data back to computing device 200, as known in the art.

At step 625, processor 204 associates the elements in the email with characteristics in the data for the group of first recipients. These characteristics are associated with the elements to later indicate which elements received positive and negative responses from recipients with the associated characteristics, as described below. For example, in one embodiment, when creating future emails, processor 204 can select a characteristic and determine which elements generated positive reactions from recipients. Similarly, in another embodiment, processor 204 can select an element and determine which characteristics of recipients that are likely to respond positively to that element.

At step 630, processor 204 receives interaction data from the recipient. In some embodiments, interaction data could include whether email was opened by the recipient, whether the recipient clicked on any hyperlinks within email, or any other interactions with the email.

At step 635, processor 204 evaluates the interaction data to determine whether it is positive or negative. For example, in some embodiments, opening the email would be considered a positive interaction. As another example, in some embodiments, designating the email as spam would be considered a negative reaction. Particular positive or negative interactions may be established when system 100 is initialized to begin the email.

At step 640, processor 204 associates the interaction data with the characteristics of the recipient. This step allows processor 204 to learn which characteristics interact positively or negatively with the email. System 100 may store the data gathered during the disclosed processes and use the data to create the first groups of recipients and first emails. Storing this data allows processor 204 to operate more efficiently by allowing system 100 to improve predictions of best recipients for future emails.

For example, if the characteristic is that a recipient shops at a particular merchant A, processor 204 may collect interaction data that shows whether a person who shops at merchant A reacted positively or negatively to the email. Processor 204 may then aggregate the interaction data of several recipients associated with shopping at merchant A to predict whether future recipients who shopped at merchant A are likely to react positively or negatively to the email.

Determining whether a characteristic is associated as a positive or negative interaction with the email can take various forms, as described above in relation to step 360 of process 300.

At step 645, processor 204 selects characteristics to define a second email and the group of second recipients. For example, an advertising campaign director may wish to send an email advertisement to consumers who have previously purchased a certain product. A computer algorithm may create various combinations of groups, such as different age groups of consumers who have shopped at a merchant. A person skilled in the art will now understand that there are other means to organize groups of desired characteristics and that those other means may be incorporated into the processes disclosed herein.

Alternatively, the selection could be based on previous iterations of the process or any other process described herein. For example, one embodiment may have a first iteration of a process that used ten characteristics. In a subsequent iteration, the process may be set to choose from the previous ten characteristics only the characteristics that received a positive interaction data score. This would allow system 100 to continue learning which of the selected characteristics that will likely respond positively to the email being sent.

At step 650, processor 204 creates a second email. Processor 204 selects elements to be included in the second email based on the interaction data associated with the selected characteristics from step 645. The particular requirements for selecting these elements can be configurable by computing device 200, for example by using the machine learning capabilities discussed above.

For example, processor 204 may add to the elements of the second email all elements positively associated with the selected characteristics by receiving a threshold number of positive responses. Similarly, processor 204 may be instructed to exclude all elements negatively associated with the selected characteristics by receiving a threshold number of negative responses. In another example, the elements of the second email may be based on the interaction data score. Processor 204 may be instructed to include all elements within a designated range or above a designated threshold of the interaction data score.

At step 655, processor 204 determines a group of second recipients. This second group of recipients is determined using the interaction data associated with selected characteristics. The requirements of the group of second recipients are configurable at the computing device 200. The group can be configured by either requiring processor 204 to add recipients from the list 210, to start with all members of the listserv and remove certain recipients from the group, or any other configuration known.

At step 660, processor 204 sends the second email to the group of second recipients. This can be accomplished through the email or messaging systems discussed above.

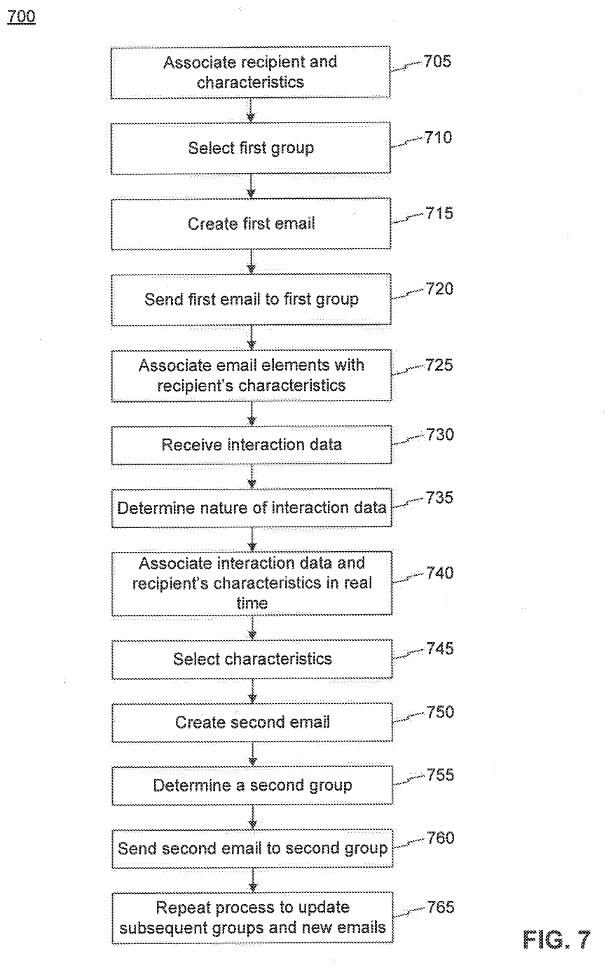

FIG. 7 is a flowchart illustrating an exemplary data handling process 700 in accordance with disclosed embodiments. Process 700 implements a system for a dynamic advertising campaign, including several steps corresponding to steps of process 600. More particularly, steps 705-735 and 745-760 of process 700 correspond to, and are substantially the same as, steps 605-635, and 645-660, respectively, of process 600. These corresponding steps are described within the description of process 600 and are not described here.

Process 700 differs primarily in steps 740 and 765. Step 740 adds a feature that matching the interaction data with the characteristics of the recipient can occur in real time. In some embodiments, this will allow system 100 to build second emails and groups of subsequent recipients based on time, rather than waiting for interaction data from all recipients. In these embodiments, the data associated with the characteristic, and the interaction data score or other metrics, will be based on the most up-to-date information, enabling the data to be used whenever it is needed.

At step 765, process 700 includes using the continually updated information on the characteristics. This allows processor 204 to repeat the previous steps of process 700 to send the second email to subsequent groups of recipients based on a designated time interval or other triggering events known in the art without waiting for responses from all previous recipients. This embodiment is not limiting on the process 600 above but is an illustration of the capabilities of the system.

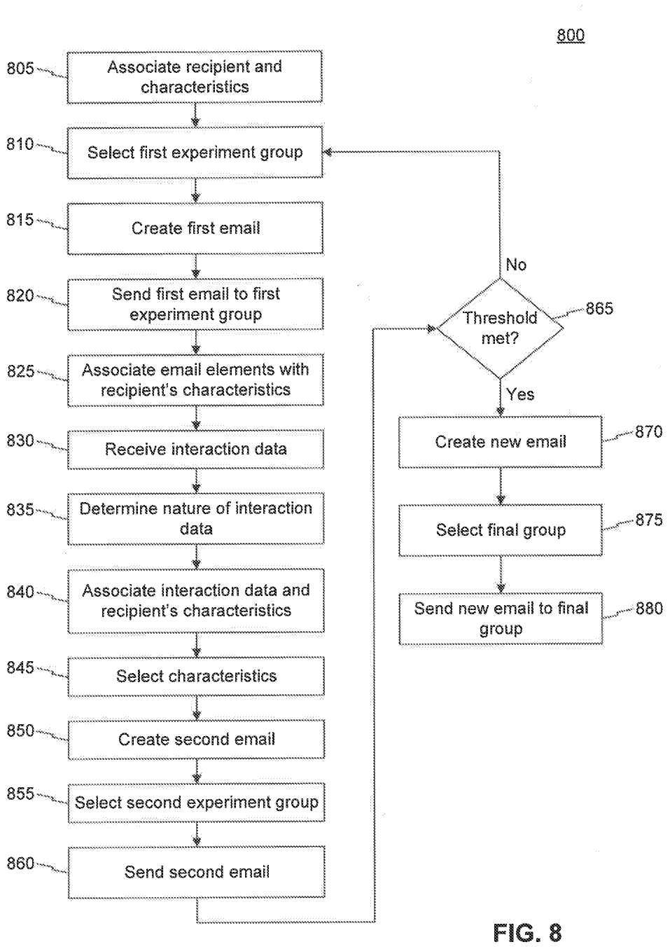

FIG. 8 is a flowchart illustrating an exemplary data handling process 800 in accordance with the disclosed embodiments. Process 800 includes several steps corresponding to steps of process 600. These corresponding steps are described within the description of process 600 and are not described here.

Process 800 differs from process 600 primarily in steps 865-880. In these steps, process 800 implements another embodiment of process 600 wherein the initial groups of recipients are run as experiments before the email is sent to a larger group of recipients. In this embodiment, processor 204 selects the group of first recipients as a first experiment.

At step 865, processor 204 collects the responses with interaction data from the second experiment, and if the interaction data meets a predetermined threshold requirement (step 865—yes), then processor 204 proceeds to step 870a to create a new email selecting elements based on the full list(s) of elements positively associated with the characteristic, as described above. At step 875, processor 204 selects a group of final recipients based on all potential recipients on list 210 with the characteristics that meet the threshold requirement.

If the threshold requirement is not met (step 865—no), then processor 204 proceeds to step 870b and repeats the earlier steps of process 800 until processor 204 identifies characteristics that meet the threshold requirement.

The threshold requirement can be selected in various ways. For example, in some embodiments, the threshold requirement may be set by a system administrator or other person involved with initializing the email. In other embodiments, the email campaign may include automated systems for creating the threshold requirement. One skilled in the art will now recognize that there are various ways to select a predetermined threshold requirement and that those processes may be implemented in process 800.

The threshold requirement can take various forms. For example, in some embodiments, the threshold requirement may be a total number of positive responses, a percentage relative to positive responses of the total number of responses, an interaction data score as described above, and/or any other qualitative measurement or analysis.

For example, in some embodiments, processor 204 may add to the new email all elements positively associated with the selected characteristics by receiving a threshold number of positive responses. Similarly, processor 204 may be instructed to exclude all elements negatively associated with the selected characteristics by receiving a threshold number of negative responses. In another example, the selected elements may be based on the interaction data score. Processor 204 may be instructed to include all elements within a designated range or above a designated threshold of the interaction data score.

As another example, processor 204 may be instructed to add to the group of second recipients all potential recipients with a characteristic that received a threshold number of positive responses. Similarly, processor 204 may be instructed to exclude all recipients associated with a characteristic that received a threshold number of negative responses. As another example, processor 204 may select the group of second recipients based on the interaction data score. Processor 204 may be instructed to include all potential recipients within a designated range or above a designated threshold of the interaction data score.

At step 880, processor 204 sends the new email to the group of final recipients. This can be accomplished through the email or messaging systems discussed above. It should also be understood that while process 600 describes system 100 as having groups of “first” and “second” emails and recipients, process 800 can be repeated and applied to as many additional emails and groups of recipients as desired. It should also be understood that minor modifications, some of which are described throughout this specification, can be implemented to adjust process 800 as needed.

Descriptions of the disclosed embodiments are not exhaustive and are not limited to the precise forms or embodiments disclosed. Modifications and adaptations of the embodiments will be apparent from consideration of the specification and practice of the disclosed embodiments. For example, the described implementations include hardware, firmware, and software, but systems and techniques consistent with the present disclosure may be implemented as hardware alone. Additionally, the disclosed embodiments are not limited to the examples discussed herein.

Computer programs based on the written description and methods of this specification are within the skill of a software developer. The various programs or program modules may be created using a variety of programming techniques. For example, program sections or program modules may be designed in or by means of Java, C, C++, assembly language, or any such programming languages. One or more of such software sections or modules may be integrated into a computer system, non-transitory computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application; such examples are to be construed as non-exclusive. Further, the steps of the disclosed methods may be modified in any manner, including by reordering steps or inserting or deleting steps. It is intended, therefore, that the specification and examples be considered as exemplary only, with the true scope and spirit being indicated by the following claims and their full scope of equivalents.

1-19. (canceled)

20. A messaging system comprising:
one or more memory devices; and
one or more processors configured to execute the instructions to:
associate each of a group of prospective recipients with at least one of a plurality of characteristics;
send an email message to a group of first recipients, the group of first recipients being selected from the group of prospective recipients, and the email message including at least one of a plurality of first elements;
associate the at least one first element with at least one of a plurality of characteristics;
receive interaction data representing a response of each first recipient of the email message to the at least one first element;
evaluate the interaction data to determine whether the response of each first recipient to the at least one first element is positive or negative;
associate the positive or negative response with the at least one characteristic of each first recipient;
select one or more of the plurality of characteristics;
create a new email message with one or more second elements based on the positive or negative responses associated with the selected characteristics; and
determine a group of second recipients to receive the new email message based on the one or more selected characteristics.

21. The messaging system of claim 1, wherein the at least one characteristic includes demographic information of the associated first recipient.

22. The messaging system of claim 1, wherein the responses indicate whether each first recipient opened the email message.

23. The messaging system of claim 1, wherein the responses indicate whether each first recipient interacted with the at least one first element of the message.

24. The messaging system of claim 4, wherein the at least one first element is a hyperlink.

25. The messaging system of claim 1, wherein creating the new email message based on the responses further includes:
creating a response score for each of the at least one first element associated with the at least one characteristic; and
including in the new email message one or more of the second elements based on the first elements that satisfy a predetermined threshold of the response score with respect to the selected characteristics.

26. The messaging system of claim 1, wherein the evaluating the interaction data includes determining that a response is positive if the response includes a predetermined positive action by the first recipient, and
wherein each of the one or more second elements is selected if a percentage of positive responses associated with the second elements as it relates to the one or more selected characteristics is greater than a predetermined percentage of a total number of the group of first recipients.

27. The messaging system of claim 1, wherein the evaluating the interaction data includes determining that a response is negative if the response includes a predetermined negative action by the first recipient, and
wherein at least one of the first elements is excluded if a percentage of negative responses is associated with the at least one first element, that is associated with the one or more selected characteristics, is greater than a predetermined percentage of a total number of the group of first recipients.

28. The messaging system of claim 1, wherein the evaluating the interaction data includes determining that a response is negative if the response includes a predetermined negative action by the first recipient, and
wherein no characteristics are selected if a percentage of negative responses is greater than a predetermined percentage of a total number of the group of first recipients.

29. The messaging system of claim 1, wherein the selected characteristics are selected based on the positive or negative feedback associated with the at least one characteristic of the first recipients.

30. The messaging system of claim 1, the processor further configured to generate subsequent email messages and recipient groups based on the responses of at least one previous recipient group.

31. A system for a dynamic advertising campaign, comprising:
one or more memory devices storing instructions;
one or more processors configured to execute the instructions to:
associate each of a group of prospective recipients with at least one of a plurality of characteristics;
send a first email message to a group of first recipients, the group of first recipients being selected from the group of prospective recipients, and the first email message including at least one of a plurality of first elements;
associate the at least one first element with at least one of a plurality of characteristics;
receive interaction data representing a response of each first recipient of the first email message to the at least one first element;
evaluate the interaction data to determine whether the response of each first recipient to the at least one first element is positive or negative;
associate the positive or negative response with the at least one of a plurality of characteristics of each recipient in real time;
select one or more of the plurality of characteristics;
create a second email message with one or more second elements based on the positive or negative responses associated with the selected characteristics; and
determine a second group of recipients to receive the second email message based on the positive or negative responses associated with the at least one of the plurality of characteristics; and
continue to create new email messages and determine subsequent groups of recipients to receive the new email messages based on positive or negative responses to an immediately preceding email message until one of a predetermined threshold of positive responses is reached or a determined amount of time is exceeded.

32. The messaging system of claim 12, wherein creating the second email message based on the responses further includes:
creating a response score for each of the at least one first element associated with the at least one of a plurality of characteristics; and
including in the second email message one or more of the second elements based on each of the at least one first element that satisfies a predetermined threshold of the response score with respect to the selected one or more characteristics.

33. The messaging system of claim 12, wherein the evaluating the interaction data includes determining that a response is positive if the response includes a predetermined positive action by the first recipient, and
wherein each of the one or more second elements is selected if a percentage of positive responses associated with the second element as it relates to the one or more selected characteristics is greater than a predetermined percentage of a total number of the group of first recipients.

34. The messaging system of claim 12, wherein the evaluating the interaction data includes determining that a response is negative if the response includes a predetermined negative action by the first recipient, and
wherein at least one of the first elements is excluded if a percentage of negative responses associated with the at least one first element, that is associated with the one or more selected characteristics, is greater than a predetermined percentage of a total number of the group of first recipients.

35. A system for a dynamic advertising campaign, comprising:
one or more memory devices storing instructions;
one or more processors configured to execute the instructions to:
associate each of a group of prospective recipients with at least one of a plurality of characteristics;
send a first email message to a group of first recipients as a first experiment, the group of first recipients being chosen from the group of prospective recipients, and the first email message including at least one of a plurality of first elements;
associate the at least one first element with at least one of the plurality of characteristics;
receive interaction data representing an interaction of each recipient with the email message, including interaction with the at least one first element;
identify positive or negative feedback in the received interaction data and associate a response to the first email message and the at least one first element by each first recipient with the at least one of a plurality of characteristics of the associated first recipient;
select each of the at least one of the plurality of characteristics associated with positive feedback;
create a second email message with one or more second elements based on the positive or negative feedback associated with the selected characteristics; and
determine a group of second recipients for a second experiment by selecting second recipients having at least one of the plurality of characteristics associated with positive feedback;
run additional experiments until results of an experiment meet a determined threshold for the at least one of the plurality of characteristics, each additional experiment being run by creating a new email message and determining an experimental group of recipients having at least one of the characteristics associated with positive feedback in a previous one of the experiments; and
send the new email message to a selected group of recipients larger than any of the groups of recipients in the experiments, the selected group of recipients being based on the at least one of the characteristics determined from the experiments to be associated with positive feedback.

36. The messaging system of claim 16, wherein creating the second email message based on the responses further includes:
creating a response score for each of the at least one first element associated with the at least one characteristic; and
including in the second email message one or more of the second elements based on each of the at least one first element that satisfies a predetermined threshold of the response score with respect to the selected characteristics.

37. The messaging system of claim 16, wherein the evaluating the interaction data includes determining that a response is positive if the response includes a predetermined positive action by the first recipient, and
wherein each of the one or more second elements is selected if a percentage of positive responses associated with the second element as it relates to the selected characteristics is greater than a predetermined percentage of a total number of the group of first recipients.

38. The messaging system of claim 16, wherein the evaluating the interaction data includes determining that a response is negative if the response includes a predetermined negative action by the first recipient, and
wherein at least one of the first elements is excluded if a percentage of negative responses associated with the at least one first element, that is associated with the at least one characteristic, is greater than a predetermined percentage of a total number of the group of first recipients.
